(19) United States
(12) Patent Application Publication
(10) Pub. No.: US 2012/0067701 A1
(43) Pub. Date: Mar. 22, 2012

(54) APPARATUS

(75) Inventor: Christof Steffen, Derendingen (CH)

(73) Assignee: MONTECH AG, Derendingen (CH)

(21) Appl. No.: 13/231,444

(22) Filed: Sep. 13, 2011

(30) Foreign Application Priority Data
Sep. 16, 2010 (DE) 10 2010 037 593.4
Sep. 16, 2010 (DE) 20 2010 008 561.6
Mar. 1, 2011 (DE) 20 2011 000 458.9

(51) Int. Cl. B65G 15/58

(52) U.S. Cl. 198/617; 198/689.1

(57) ABSTRACT

In a vacuum conveyor belt for receiving, conveying and depositing planar objects, wherein the vacuum conveyor belt has a circulating drive (16), and a U-profile (3), wherein the U-profile (3) has a conveying passage and a return passage, and a conveyor belt (8), wherein the U-profile (3) on the return passage side includes a holder element (5).

### BACKGROUND OF THE INVENTION

The invention relates to a vacuum conveyor belt, a regulating valve for regulating the vacuum and a method for conveying a planar object with the vacuum conveyor belt.

Various vacuum conveyor belts, as well as valves, are known and common from the prior art. In addition, for the processing or working of planar objects, use is made of multi-axis robots, which have the drawback, however, that an empty return run generally has an adverse effect upon efficiency and cost structure in respect of reception, conveyance and depositing. Added to this is the fact that, though the robot arms can perform the required four to six thousand handling motions per hour, the planar objects to be conveyed, specifically in the case of solar wafers or solar cells, which are by now made very thin, and a corresponding acceleration of the robot arm, can lead to damage. In addition, the drawback is evident that the multi-axis robots can only receive, convey and deposit just one planar object each. This is likewise disadvantageous for the efficiency of such a machine.

The object of the invention is to define a vacuum conveyor belt, as well as a valve for regulating the vacuum of the vacuum conveyor belt, with which the drawbacks of the prior art are remedied or at least alleviated. More particularly, the object of the invention is to provide a vacuum conveyor belt which not only treats planar objects gently, but also works efficiently and cost-effectively.

### SUMMARY OF THE INVENTION

The object is achieved with a vacuum conveyor belt and a valve for controlling the vacuum and a method for transporting planar objects as described below.

The vacuum conveyor belt according to the invention is suitable for receiving, conveying and depositing planar objects. Reception preferably means in this context that a supplied planar object is drawn up to the vacuum conveyor belt by the vacuum generation. In the same way, it is also conceivable, however, that, if the planar object is led up from below, a spring is arranged in such a way that the planar object is placed directly against the vacuum conveyor belt and the vacuum conveyor belt merely implements the holding of the planar object. This fact too can be referred to as reception. In a preferred illustrative embodiment, the conveyance of the planar object includes the transport by means of a revolving vacuum conveyor belt around a U-profile according to the invention. The direction and speed of the conveyance is governed by the shape of the U-profile and the speed at which the vacuum conveyor belt is driven. In a preferred illustrative embodiment, the focus is on the depositing of the planar object. By depositing shall here be meant that either the vacuum conveyor belt no longer has negative pressure and hence the planar object falls, or it is lifted off the vacuum conveyor belt. Similarly, it can be part of the depositing if the planar object is released from the conveyor belt by a scraper. Advantages with respect to the use of a vacuum conveyor belt are cost efficiency and the prevention of empty runs in the course of the process.

The vacuum of an inventive illustrative embodiment of the vacuum conveyor belt has a circulating drive. This consists of a toothed belt wheel driven by an electric motor. The cogwheel is operatively connected to a toothed belt profile configured on the bottom side of the vacuum conveyor belt. The bottom side means that side which is facing toward the planar object to be conveyed. The fact that the circulating drive requires less energy and is durable is here advantageous. In addition, it is advantageous that such electric drives nowadays have a very long life and require little space.

An illustrative embodiment according to the invention also has a U-profile, the U-profile comprising a conveying passage and a return passage. Traditionally in vacuum conveyor belts, the top side of the vacuum conveyor belt is regarded as the conveying passage. The return passage is in this case realized on the bottom side of the U-profile, which usually is not suitable for the conveyance. The shape and size of the U-profile is governed by the requirements of the planar objects to be conveyed. For this, hollow profiles in modular construction, which have the advantage of offering greatest possible flexibility for adapting to all customer requirements, are generally used.

In a preferred illustrative embodiment, solar wafers, solar cells, solar strings, compact disks (CDs), DVDs, paper, cardboard packagings or planar components from the electrical or metal industry are regarded as planar objects.

In a preferred illustrative embodiment, the vacuum conveyor belt is driven from the interaction of the toothed belt profile with the circulating drive. It is here in turn advantageous that an energy-efficient conversion of the drive to a circulatory motion of the vacuum conveyor belt is enabled.

A preferred illustrative embodiment has a chamber in the U-profile. This chamber is connected by a valve to a vacuum source. The chamber serves as a buffer for supplying the vacuum conveyor belt with negative pressure. This has the advantage that no complex tube construction up to the vacuum conveyor belt has to be provided.

Another preferred illustrative embodiment of a vacuum conveyor belt according to the invention is designed in such a way that the holder element comprises at least one supply line and a vacuum basin. In this case, also a plurality of supply lines can open out into a vacuum basin. The supply line here forms the bridge between the vacuum basin of the holder element and the vacuum buffer. The fact that a fine adjustment is able to be made by adjusting the diameter of the supply line and the depth or length or diameter of the vacuum basin in order appropriately to conform to the planar objects to be transported, and the weight and properties thereof, is here in turn advantageous.

Preferably, the U-profile is made up of a plurality of portions. These portions preferably have a total length of 50 mm to 300 mm, preferably 100 mm to 250 mm, still more preferably 160 mm to 220 mm. The advantage with this is the fact that the division of the portions of the U-profile enables an accurate as possible pressure adjustment to be made in relation to the planar object to be conveyed and its properties, such as weight and shape.

Preferably, the vacuum basins formed in the holder element are also made up of mutually separated portions. These portions likewise have a total length of 50 mm to 300 mm, preferably 100 mm to 250 mm, still more preferably 160 mm to 220 mm. Generally, the total length of the portion of the vacuum basin is matched to the total length of the portion of the U-profile. A negative pressure profile which is made as uniform as possible and exhibits an equal negative pressure throughout the length of the portion is here advantageous.

By virtue of the holder element according to the invention, it is possible to design a here-described vacuum conveyor belt in such a way that it can be used to transport planar objects on the conveying passage side and/or on the return passage side. This arises from the fact that the holder element prevents sagging of the vacuum conveyor belt on the return passage side. As a result of this sagging, the negative pressure would otherwise be gilded sideways such that planar objects can no longer be held. In this context, a very high flexibility in the use of vacuum conveyor belts according to the invention is advantageous.

Another preferred illustrative embodiment is designed in such a way that a vacuum conveyor belt according to the invention initially conveys a planar object on the return passage side and then transfers it onto the conveying side of another vacuum conveyor belt for onward transport. The further vacuum conveyor belt can here be equipped without a holder element, as is customary in the prior art. This operation can optionally be continued and allows very high flexibility of use.

In a preferred illustrative embodiment, a valve for the vacuum regulating system or vacuum circuit of the vacuum conveyor belt according to the invention is provided. The vacuum circuit serves to generate the ejector pulse whereby the planar object to be conveyed is delivered. This valve has an inlet. This inlet is designed in such a way that a negative pressure is generated by a vacuum source via lines, which negative pressure is led up to the housing of the valve via the inlet. The shape and form of the housing can be ignored, since they are generally adjusted to given basic conditions and cannot therefore be uniform. The inlet merely produces an airtight transfer of the connections from the vacuum source to the valve. The advantage with this is the fact that the least possible negative pressure is lost. The valve housing according to the invention also has an inner chamber. This inner chamber advantageously serves to regulate the valve. Moreover, in a preferred illustrative embodiment of a valve according to the invention, at least one outlet is provided. This outlet appears as a tubular configuration of the housing. The outlet serves to establish a connection of the valve to the vacuum conveyor belt. A connection of the valve to the vacuum conveyor belt which is as secure, simple and cost-effective as possible is here advantageous.

An illustrative embodiment according to the invention also has an additional compressed air supply. This compressed air supply is designed in such a way that it is connected by a line to the inner chamber of the housing and supplies via lines through a compressed air source.

The compressed air supply is preferably designed such that, by the injection of compressed air into the inner chamber, the diversion element is shifted from a rest position into a working position. This happens specifically by virtue of the fact that the diversion element, which can be displaceably mounted, for instance, in a rail or guide system, is displaced from a rest position into a working position by the introduction of compressed air. This happens specifically by virtue of the fact that as a result of the displacement of the diversion element to the inlet, which inlet is initially in the rest position closed off, a bypass is formed between inlet and outlet, which in turn means that the diversion element is subsequently in the working position. In the preferred illustrative embodiment, the inlet is fitted on the side facing away from the planar object which is later to be held. The outlet is fitted at roughly a 90° angle on a side wall of the housing. The diversion element is tubular and forms an approximately 90°-bent borehole or piston. The fact that the actuation of the valve is wholly without electrical drive or other control mechanisms, but is enabled only by the introduction of compressed air into the inner chamber, is here advantageous. In another illustrative embodiment, it is conceivable that the valve is actuated by an electric circuit or an electrically operated valve. The advantage would here be that a rapid switchover is enabled. The displaceability of the diversion element is delimited by two stops. Depending on from which end face of the housing the compressed air is blown in, the diversion element is displaced either to that stop or to the other stop.

Another preferred illustrative embodiment of a valve according to the invention also has a sensor, suitable for detecting the position of the diversion element. The sensor can here be of different configuration. Depending on the field of application or the difference in user, an ultrasonic sensor, an optoelectronic sensor, but also resistive sensors, inductive sensors, differential transformers, inductive displacement transducers, eddy current sensors, inductive proximity sensors, magnetoelastic sensors, piezoelectronic sensors or temperature sensors enter into consideration as sensors. The fact that the sensor enables the precise position of the by-pass line to be portrayed at any point of the working or rest position is here in turn advantageous.

In a preferred illustrative embodiment, the valve and the vacuum conveyor belt is controlled by a central processing unit and mutually coordinated. This advantageously enables a smooth running of the entire process.

A method according to the invention for receiving, conveying and depositing a planar object has as the first step the supply of a planar object to the return passage of the vacuum conveyor belt. This supply can be realized either automatically, by an appropriate feeder device, or by the particular configuration of obliquely placed feeder surfaces formed in the shape of a slide. As the return passage of the vacuum conveyor belt is here meant the bottom side of the vacuum conveyor belt, which in traditional vacuum conveyor belts from the prior art cannot be utilized.

After this, compressed air is blown into the inner chamber of the valve, so that the by-pass line is displaced up to the stop in accordance with the predefined guides. The valve is thereby shifted from the rest position into the working position. The negative pressure which was present in the inlet is now extended by the diversion element into the chamber of the vacuum conveyor belt. From the chamber of the vacuum conveyor belt, the negative pressure extends onward via the supply line of the holder element into the vacuum basin. There, on the basis of the working position, a negative pressure is formed, which negative pressure, by virtue of the openings in the vacuum conveyor belt, causes a planar object to be received. The fact that the entire process can proceed in an energy-efficient, quick and smooth manner is here advantageous. In a preferred method, the object is drawn up onto the side of the return passage of the vacuum conveyor belt, and held there, by the negative pressure generated on the return passage. Next, the vacuum conveyor belt is moved by the circulating drive, which in turn results in the planar object, likewise on the side which is upside down, being moved to the return passage side of the vacuum conveyor belt. This has the advantage that the previously intricately designed superstructures, which were necessitated by the previously sole possibility of use of a vacuum conveyor belt by conveyance on the top side of the vacuum conveyor belt, can now be dispensed with.

The bottom side of the U-profile is referred to as the return passage. The conveying side is the top side of the U-profile. In this context, the bottom side in turn means the side which points to the floor of a production site.

The circulating drive, in interaction with the vacuum conveyor belt, now effects the evacuation of the planar object from the reception region to the depositing region. If the valve is intended to be shifted back out of the working position into the rest position, on the other end face of the valve housing compressed air is in turn blown into the inner chamber of the valve, so that the diversion element is displaced to the other stop. The inlet is thereby closed off and the connection between inlet and outlet broken. In turn, the vacuum conveyor belt is hence no longer supplied with negative pressure, which results in the planar object falling from the vacuum conveyor belt, down into a predefined location, due to its gravitational force. The fact that it is possible to determine precisely at which moment or place the planar object is to fall from the vacuum conveyor belt is here in turn advantageous.

In a preferred illustrative embodiment of a method according to the invention, the place of use of the rest position of the vacuum conveyor belt according to the invention can also be designed in such a way that another vacuum conveyor belt is positioned with the conveying passage, i.e. the top side, such that the planar object can be drawn, taken or let from the return passage side of one vacuum conveyor belt onto the conveying passage side of the further vacuum conveyor belt. The fact that a gentle transfer of the planar object from the vacuum conveyor belt to the further vacuum conveyor belt can be executed without possible damage to the planar object is here advantageous. A smooth and rapid transfer of the planar object between the two vacuum conveyor belts is also advantageous.

In a preferred illustrative embodiment, the planar object can now be evacuated on the conveying passage of the further conveyor belt by the use of a further circulating drive. The fact that this transfer and the evacuation can be modularly constructed, and therefore an adaptation to the needs and requirements of each planar object or customer or user can be provided, is here in turn advantageous.

Another preferred illustrative embodiment of a method according to the invention is designed in such a way that more than two valves according to the invention can be interconnected with at least one vacuum conveyor belt. This in turn has the advantage that a higher efficiency increase can be achieved, since a plurality of planar objects can be received, evacuated and deposited at once with one and the same vacuum conveyor belt.

### BRIEF DESCRIPTION OF THE DRAWINGS

Further advantages and features of preferred embodiments of the invention are explained below with reference to the appended drawing, wherein:

FIG. 1 shows a partially sectioned side view of an inventive embodiment of the vacuum conveyor belt;

FIG. 2 shows an enlarged view of a part according to FIG. 1;

FIG. 3 shows a schematic view of a part of a vacuum conveyor belt according to the invention from diagonally below;

FIG. 4 shows a schematic view from diagonally below of an illustrative embodiment of a valve according to the invention;

FIG. 5 shows a side view of the valve according to FIG. 4;

FIG. 6 shows a sectioned view from below along the sectional line A-A according to FIG. 5;

FIG. 7 shows a sectioned side view of FIG. 5 along the sectional line B-B.

### DETAILED DESCRIPTION

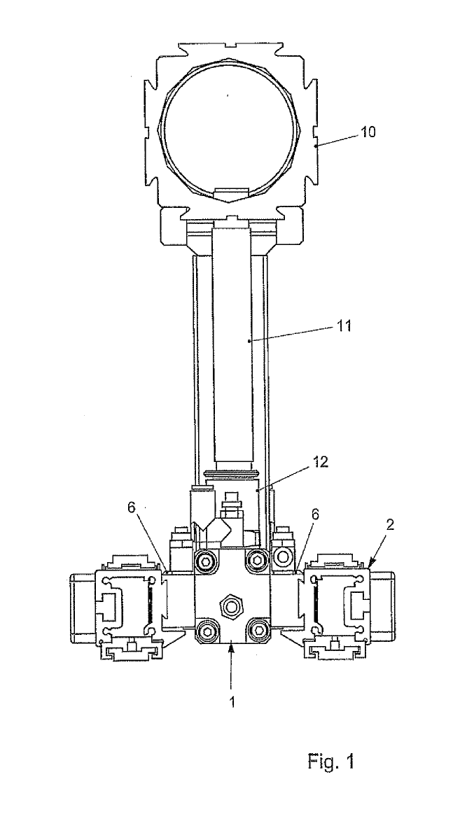

In FIG. 1, a vacuum source 10 is first shown. From this vacuum source 10, a pipe 11 runs into an inlet 12, which in turn establishes the connection to a valve 1. Running in turn from this valve 1 is an outlet 6, which in turn establishes the connection between the valve 1 and the vacuum conveyor belt 2.

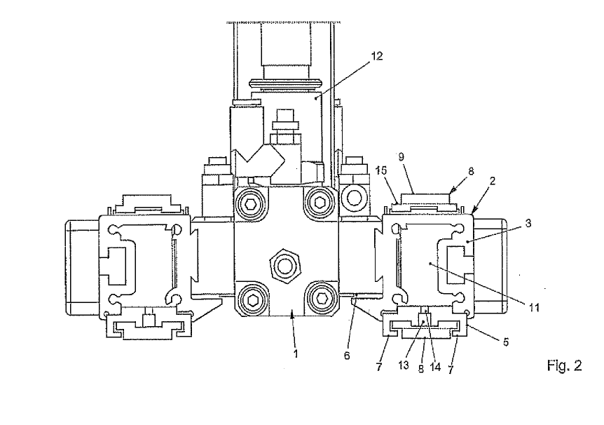

In FIG. 2, the region of the vacuum conveyor belt 2 and the valve 1 of the valve 1 is shown more closely. The vacuum conveyor belt 2 has in turn a U-profile 3. On the bottom side of the U-profile 3, moreover, is shown a holder element 5. This holder element 5 in turn has two retaining arms 7, which are intended to prevent the revolving conveyor belt 8 from being pulled downward by gravitational force. In this context, downward means onto the side facing away from the inlet 12. The conveyor belt 8 consists of a top side 9 and a bottom side 15, the bottom side 15 being configured as a toothed belt. In FIG. 2, the bottom side 15 is separated from the top side 9 by a dashed line. The apparatus 2 also has a chamber 11. Negative pressure can be applied to this chamber 11 through the outlet 6. It is also evident how a vacuum basin 13 and a supply line 14 is formed into the holder element 5.

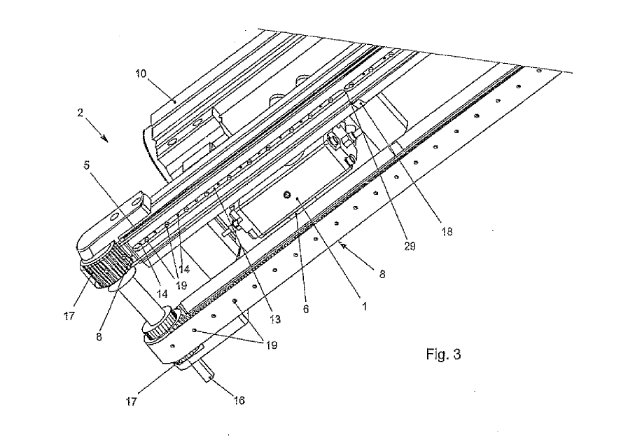

In FIG. 3 in turn, a view from diagonally below is shown. In the sectioned view of one vacuum conveyor belt, it can clearly be seen how openings 19 are formed into the conveyor belt 8. A circulating drive 16 is also shown, which, via at least one toothed belt wheel 17, revolvingly moves the conveyor belt 8. In addition, in the sectioned view of a conveyor belt 8, it can clearly be seen how a plurality of supply lines open out into the vacuum basin 13. It is also evident how the total length of the vacuum basin are roughly matched to a portion of the U-profile. The start and end of the portion is illustrated by a marking 18. The start and end of the portion of the vacuum basin is shown by a bridge 29.

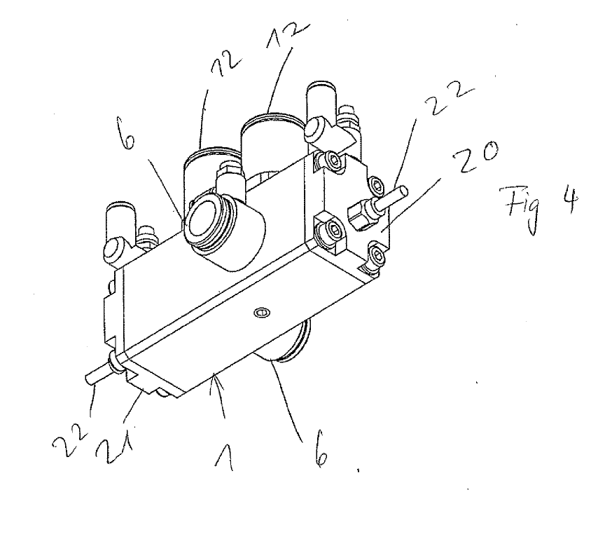

In FIG. 4 in turn, the valve 1 is once again shown separately. There it can clearly be seen how a sensor 22 is respectively embedded on the end faces 20 and 21. Moreover, the outlets, bearing the reference numeral 6, and the inlets 12 are clearly visible.

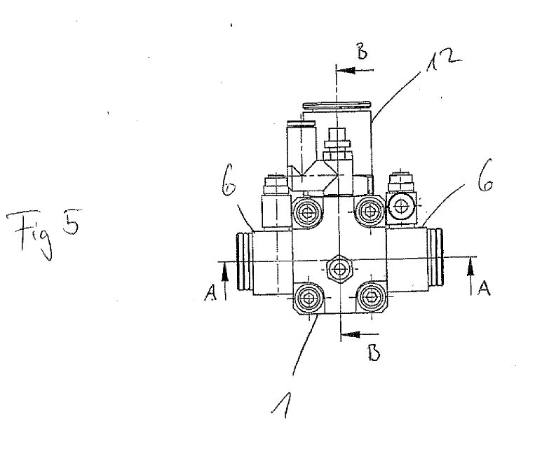

In FIG. 5, a side view of FIG. 4 is shown, wherein two sectional lines A-A and B-B are illustrated.

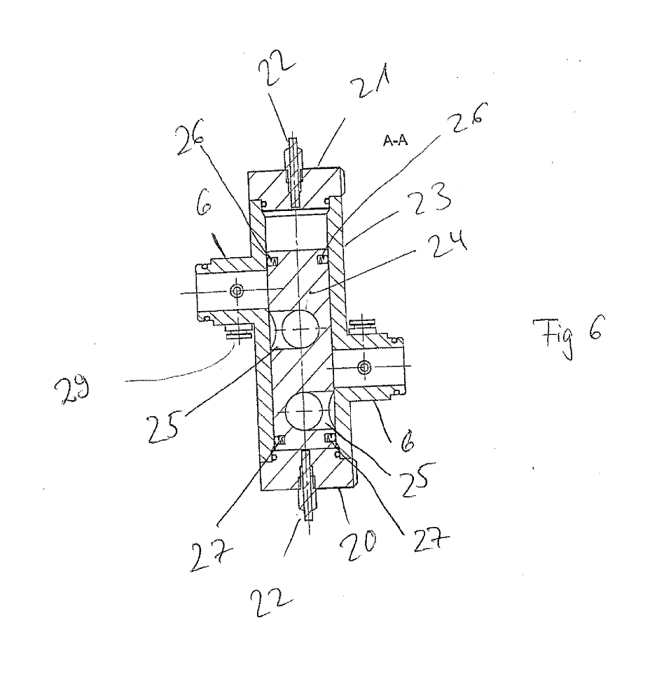

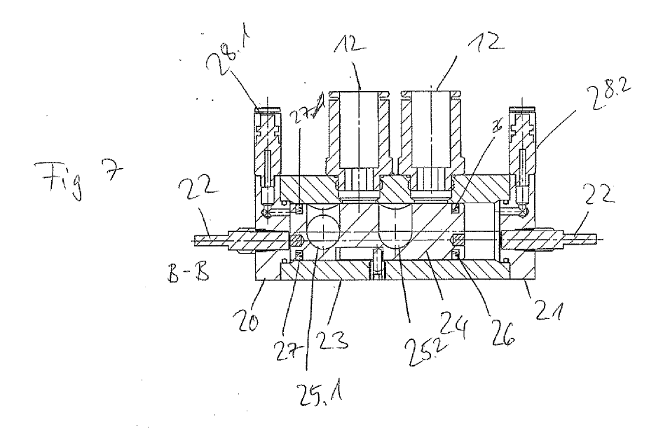

In FIG. 6 in turn, the sectioned view along the sectional line A-A is now shown. It can there be seen how a piston 24 is present in a housing 23. In the piston 24, in turn, two diversion elements 25 and respectively two stops 26 and 27 are disposed. The stops 26, 27 are preferably in the form of seals, which prevent the escape of compressed air. In that position of the diversion elements 25 which is shown in FIG. 6, the outlet 6 is blocked. As is evident from the combined view of FIGS. 6 and 7, the sensors lie in the same surface plane, but mutually offset. A sensor 22 is respectively provided to detect the position of a diversion element 25. The individual features and parts shown in FIG. 7 correspond to those in FIG. 6. Double mentions of the individual reference numerals are therefore dispensed with, unless they require a separate nomenclature. In FIG. 7, a compressed air intake 28 is also shown. This compressed air intake is fitted above the sensors. In the position shown in FIG. 7, the compressed air supply 28.2, through the injection of compressed air, has led the diversion element 25.1 to be pushed against the stop 27 and the connection between the inlet 12 and the outlet 6 (not shown in FIG. 7) is thereby broken. If the compressed air supply 28.1 were now to shoot compressed air into the inner chamber 24, this would lead the diversion element 25.1 to be moved up to the stop 26 until the diversion element 25.2 butts against the stop 26. In this position, the connection between the inlet 12 and the outlet 6 would then be established, which would in turn have the effect of generating in the inner chamber 11 of the vacuum conveyor belt 2 a negative pressure which would extend also into the vacuum basin 13 via the supply line 14.

In addition, FIG. 6 shows how an ejector pulse inlet 29 is present. Through the ejector pulse inlet 29, compressed air is blown into the interior of the housing 23, which brings about the ejection of the planar object to be conveyed. For this purpose, a short compressed air pulse is preferably applied via a compressed air hose (not shown in detail) via the ejector pulse inlet 29. This can be realized, for instance, by displacement of the diversion element 25 by the introduced compressed air such that the planar object to be conveyed is cut off from the negative pressure source or the diversion element 25 is used such that, instead of a negative pressure, a compressed air pulse is transmitted to the planar object to be conveyed. The first variant has the advantage that the planar object to be conveyed is not directly subjected to compressed air and is thus gently treated. On the other hand, the second variant has the advantage that the planar object to be conveyed can be rapidly separated from the apparatus.

1. Vacuum conveyor belt for receiving, conveying and depositing planar objects, comprising: a circulating drive (16); a U-profile (3), wherein the U-profile (3) comprises a conveying passage and a return passage; and a conveyor belt (8); wherein the U-profile (3) on the return passage side comprises a holder element (5) and at least one retaining arm (7).

2. Vacuum conveyor belt according to claim 1, wherein the conveyor belt (8) has a toothed belt profile, wherein the toothed belt profile cooperates with the circulating drive (16).

3. Vacuum conveyor belt according to claim 2, further including a chamber (11) in the U-profile for supplying the conveyor belt (8) with negative pressure.

4. Vacuum conveyor belt according to claim 3, wherein the holder element (5) comprises at least one supply line (14) and a vacuum basin (13).

5. Vacuum conveyor belt according to claim 4, wherein the supply line (14) is connected to the chamber (11).

6. Vacuum conveyor belt according to claim 1, including a housing (23) and an ejector pulse inlet (29) formed on the housing (23).

7. Vacuum conveyor belt according to claim 1, wherein the U-profile (3) is made up of sections.

8. Vacuum conveyor belt according to claim 4, wherein the vacuum basin (13) is formed in the holder element (5) and is made up of mutually separated portions.

9. Vacuum conveyor belt according to claim 3, including a valve for regulating the negative pressure, the valve comprises:
an inlet (12);
a housing (23) and an inner chamber (24);
an outlet (6); and
a compressed air intake (28).

10. Vacuum conveyor belt according to claim 9, wherein at least one diversion element (25) is disposed in the inner chamber (24), wherein the diversion element (25) is displaceably guided in the inner chamber (24) by compressed air and wherein the housing (23) comprises a sensor (22), suitable for detecting the position of the diversion element (25).

11. Vacuum conveyor belt according to claim 10, wherein the outlet (6) is connected to the chamber (11), wherein the diversion element (25), in the working position, establishes a connection between the inlet and the outlet and wherein at least two stops (26, 27) are present in the inner chamber (24).

12. Method for receiving, conveying and depositing a planar object by a vacuum conveyor belt comprising: a circulating drive (16), a U-profile (3), wherein the U-profile (3) comprises a conveying passage and a return passage, and a conveyor belt (8), wherein the U-profile (3) on the return passage side includes a holder element (5) and at least one retaining arm (7), the U-profile includes a chamber (11) for supplying the conveyor belt (8) with negative pressure, a valve for regulating a negative pressure, the valve comprises an inlet (12), a housing (23) and an inner chamber (24), an outlet (6), and a compressed air intake (28), the method comprising the steps of:
supplying a planar object to the return passage of the vacuum conveyor belt (2),
blowing compressed air into the inner chamber (24) of the valve (1), suitable for displacing the diversion element (25),
establishing a connection between the inlet (12) and the outlet (6) of the valve (1), whereby vacuum is generated in the chamber (11) and thus also in the vacuum basin (13) and the supply line (14),
drawing the planar object onto the side of the return passage,
moving the conveyor belt (8) by the circulating drive (16) up to an intermediate destination station,
blowing compressed air into the inner chamber (24) of the valve (1), so that the diversion element (25) is displaced and closes off the inlet (12) and the connection between the inlet (12) and the outlet (6) is broken,
triggering an ejector pulse by the introduction of compressed air via an ejector pulse inlet (29) into the interior of the housing (23), suitable for separating the planar object from the conveyor belt (8),
delivering the planar object to the intermediate destination station, and
evacuating the planar object from the intermediate destination station.

13. Method according to claim 12, wherein more than two valves are interconnected with the vacuum conveyor belt (2), wherein, during the conveyance of the planar object, the vacuum is passed on to a vacuum basin (13) of the holder element (5) which is suitable for preventing the planar object from sliding off.
